(19) United States
(12) Patent Application Publication
(10) Pub. No.: US 2013/0113887 A1
(43) Pub. Date: May 9, 2013

(54) APPARATUS AND METHOD FOR MEASURING 3-DIMENSIONAL INTEROCULAR CROSSTALK

(71) Applicant: LG ELECTRONICS INC., Seoul (KR)

(72) Inventors: Myungjae JEON, Pyeongtaek-si (KR); Seonghak MOON, Pyeongtaek-si (KR); Junhak LEE, Pyeongtaek-si (KR)

(73) Assignee: LG ELECTRONICS INC., Seoul (KR)

(21) Appl. No.: 13/673,718

(22) Filed: Nov. 9, 2012

Related U.S. Application Data
(60) Provisional application No. 61/557,421, filed on Nov. 9, 2011.

(51) Int. Cl. H04N 13/02

(52) U.S. Cl. 348/46; 348/E13.064

(57) ABSTRACT

An apparatus and method for measuring 3-dimensional (3D) interocular crosstalk is disclosed. A light sensor detects luminance of a stereoscopic image displayed in a display and outputs a luminance value indicating the detected luminance. A controller calculates 3D interocular crosstalk based on a gray difference and a residual luminance ratio.

This application claims the benefit of U.S. Provisional Patent Application No. 61/557,421, filed on Nov. 9, 2011, which is hereby incorporated by reference in their entirety.

### BACKGROUND OF THE INVENTION

1. Field of the Invention

The present invention relates to an apparatus and a method for measuring 3-dimensional (3D) interocular crosstalk, and more particularly, to an apparatus and a method for measuring 3D interocular crosstalk, which is able to measure 3D interocular crosstalk of a stereoscopic image being processed to be presented in a display.

2. Discussion of the Related Art

Analog broadcast environments have been rapidly transitioned to digital broadcast environments. Thus, the amount of content for digital broadcasts has been considerably increased. In addition, as content for digital broadcasts, content for displaying a three-dimensional (3D) image signal as a 3D image has been produced in addition to content for displaying a 2-dimensional (2D) image signal as a 2D image.

A technique of displaying a 3D image uses the principle of binocular disparity so as to enable a viewer to perceive a 3D effect and includes a glasses method, a non-glasses method, and a full-3D method. A user may need to wear a separate device (or 3D glasses) such as polarized glasses and shutter glasses in the glass method.

Stereoscopic displays separate the left and right images using 3D glasses. When the left and right images are not separated perfectly, an unwanted ghost image appears at the other side, which is called 3D interocular crosstalk.

3D displays with high interocular crosstalk level cause some trouble such as dizziness, sickness, etc.

Therefore, it is one of the most important factors in 3D display to measure exact 3D crosstalk level quantitatively.

### SUMMARY OF THE INVENTION

Accordingly, the present invention is directed to an apparatus and a method for measuring 3-dimensional (3D) interocular crosstalk that substantially obviate one or more problems due to limitations and disadvantages of the related art.

An object of the present invention is to provide an apparatus and a method for measuring 3D interocular crosstalk, which is able to measure 3D interocular crosstalk considering pixel distribution of real video contents.

Another object of the present invention is to provide an apparatus and a method for measuring 3D interocular crosstalk, which is able to measure 3D interocular crosstalk considering gray-to-gray (G2G) conditions.

Another object of the present invention is to provide an apparatus and a method for measuring 3D interocular crosstalk, which is able to provide 3D interocular crosstalk measurement setup and condition.

Another object of the present invention is to provide an apparatus and a method for measuring 3D interocular crosstalk, which is able to provide 3D interocular crosstalk measurement formula.

Another object of the present invention is to provide an apparatus and a method for measuring 3D interocular crosstalk, which is able to provide 3D interocular crosstalk measurement patterns.

Another object of the present invention is to provide an apparatus and a method for measuring 3D interocular crosstalk, which is able to provide 3D interocular crosstalk measurement report.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for measuring 3-dimensional (3D) interocular crosstalk includes a light sensor configured to detect luminance of a stereoscopic image displayed in a display and output a luminance value indicating the detected luminance, and a controller configured to calculate 3D interocular crosstalk based on a gray difference and a residual luminance ratio, wherein the gray difference is calculated based on gray levels of a first view image and a second view image included in the stereoscopic image and the residual luminance ratio is calculated based on the luminance value.

The stereoscopic image is displayed in a glasses method or a non-glasses method.

The light sensor detects luminance of the stereoscopic image passing 3D glasses.

The gray difference is multiplied by the residual luminance ratio to calculate the 3D interocular crosstalk.

The gray difference is calculated further based on the display's Gamma (γ) value.

The gray difference is calculated by the following equation (1),

$${D}_{G 1 , G 2} = {( \frac{G 2}{255} )}^{γ} - {( \frac{G 1}{255} )}^{γ}$$

The following equation (1)

wherein, in the equation (1), G1 is the first view image's gray level, G2 is the second view image's gray level, D_{G1,G2} means the gray difference, and Γ is the display's Gamma (γ) value.

The residual luminance ratio is calculated by the following equation (2),

$${R}_{G 1 , G 2} = \frac{{L}_{G 1 , G 2} - {L}_{G 2 , G 2}}{{L}_{G 2 , G 1} - {L}_{G 2 , G 2}} \qquad$$

The following equation (2)

wherein, in the equation (2), G1 is the first view image's gray level, G2 is the second view image's gray level, L_{G1,G2} is a luminance value indicating the luminance detected by the light sensor when the first view image is for an observed image and the second view image is for an unobserved image, L_{G2,G1} is a luminance value indicating the luminance detected by the light sensor when the first view image is for an unobserved image and the second view image is for an observed image, L_{G2,G2} is a luminance value indicating the luminance detected by the light sensor when the stereoscopic image includes two second view images and one of the two second view images is for an observed image and another is for an unobserved image, and R_{G1,G2} means the residual luminance ratio.

The controller calculates the 3D interocular crosstalk using the following equation (3) or the following equation (4),

$$\begin{matrix}{X}_{LO , G 1 , G 2} = ( {( \frac{G 2}{255} )}^{γ} - {( \frac{G 1}{255} )}^{γ} ) \times \frac{{L}_{LO , G 1 , G 2} - {L}_{LO , G 2 , G 2}}{{L}_{LO , G 2 , G 1} - {L}_{LO , G 2 , G 2}} \times 100 \% & Equation ( 3 ) \\ {X}_{RO , G 1 , G 2} = ( {( \frac{G 2}{255} )}^{γ} - {( \frac{G 1}{255} )}^{γ} ) \times \frac{{L}_{RO , G 1 , G 2} - {L}_{RO , G 2 , G 2}}{{L}_{RO , G 2 , G 1} - {L}_{RO , G 2 , G 2}} \times 100 \% & Equation ( 4 )\end{matrix}$$

wherein, in the equation (3) and the equation (4), G1 is the first view image's gray level, G2 is the second view image's gray level, Γ is the display's Gamma (γ) value, L_{LO,G1,G2} is a luminance value indicating the luminance detected by the light sensor when the first view image is for an observed image on a left lens of 3D glasses and the second view image is for an unobserved image on the left lens, L_{LO,G2,G1} is a luminance value indicating the luminance detected by the light sensor when the first view image is for an unobserved image on left lens and the second view image is for an observed image on the left lens, L_{LO,G2,G2} is a luminance value indicating the luminance detected by the light sensor when the stereoscopic image includes two second view images and one of the two second view images is for an observed image on the left lens and another is for an unobserved image on the left lens, L_{RO,G1,G2} is a luminance value indicating the luminance detected by the light sensor when the first view image is for an observed image on a right lens of the 3D glasses and the second view image is for an unobserved image on the right lens, L_{RO,G2,G1} is a luminance value indicating the luminance detected by the light sensor when the first view image is for an unobserved image on right lens and the second view image is for an observed image on the right lens, L_{RO,G2,G2} is a luminance value indicating the luminance detected by the light sensor when the stereoscopic image includes two second view images and one of the two second view images is for an observed image on the right lens and another is for an unobserved image on the right lens, and X_{LO,G1,G2} and X_{RO,G1,G2} means the influence of G2 to G1, which are measured on the left lens and right lens, respectively.

The gray level includes at least one of a red gray level, a green gray level or a blue gray level.

An image pattern of the first view image includes 4% sized window box pattern and four box patterns of 1% sized window.

The 4% sized window box pattern are located at the center of the first view image and each of the four box patterns of 1% sized window is located at the corners of the first view image.

The sum of gray level of the 4% sized window box pattern and the four box patterns of 1% sized window is a maximum gray level.

An image pattern of the stereoscopic image is determined according to a display mode.

The display mode includes at least one of a gray mode, a red color mode, a green color mode or a blue color mode.

The controller generates 3D interocular crosstalk measurement report including at least one of measured 3D interocular crosstalk values of each of gray pairs (G1, G2), an average value of additive and subtractive interocular crosstalk or a peak value of additive and subtractive interocular crosstalk, wherein G1 is the first view image's gray level and G2 is the second view image's gray level.

In another aspect of the present invention, a method of measuring a three-dimensional (3D) interocular crosstalk includes displaying a full white pattern image, displaying a first stereoscopic image including a first view image for an observed image and a second view image for an unobserved image, displaying the full white pattern image, displaying a second stereoscopic image including the first view image for an unobserved image and the second view image for an observed image, displaying a full white pattern image, and displaying a third stereoscopic image including two second view image.

The method further includes detecting a first luminance of the displayed first stereoscopic image, detecting a second luminance of the displayed second stereoscopic image, detecting a third luminance of the displayed third stereoscopic image, and calculating 3D interocular crosstalk based on the detected first luminance, the detected second luminance and the detected third luminance.

The 3D interocular crosstalk is calculated further based on gray levels of the first view image and the second view image.

The 3D interocular crosstalk is calculated further based on a display's Gamma (γ) value.

The 3D interocular crosstalk is calculated by the following equation (5) or the following equation (6),

$$\begin{matrix}{X}_{LO , G 1 , G 2} = ( {( \frac{G 2}{255} )}^{γ} - {( \frac{G 1}{255} )}^{γ} ) \times \frac{{L}_{LO , G 1 , G 2} - {L}_{LO , G 2 , G 2}}{{L}_{LO , G 2 , G 1} - {L}_{LO , G 2 , G 2}} \times 100 \% & Equation ( 5 ) \\ {X}_{RO , G 1 , G 2} = ( {( \frac{G 2}{255} )}^{γ} - {( \frac{G 1}{255} )}^{γ} ) \times \frac{{L}_{RO , G 1 , G 2} - {L}_{RO , G 2 , G 2}}{{L}_{RO , G 2 , G 1} - {L}_{RO , G 2 , G 2}} \times 100 \% & Equation ( 6 )\end{matrix}$$

wherein, in the equation (5) and the equation (6), G1 is the first view image's gray level, G2 is the second view image's gray level, Γ is the display's Gamma (γ) value, L_{LO,G1,G2} is a luminance value indicating the luminance of the first stereoscopic image detected on a left lens of 3D glasses, L_{LO,G2,G1} is a luminance value indicating the luminance of the second stereoscopic image detected on the left lens, L_{LO,G2,G2} is a luminance value indicating the luminance of the third stereoscopic image detected on the left lens, L_{RO,G1,G2} is a luminance value indicating the luminance of the first stereoscopic image detected on a right lens of the 3D glasses, L_{RO,G2,G1} is a luminance value indicating the luminance of the second stereoscopic image detected on the right lens, L_{RO,G2,G2} is a luminance value indicating the luminance of the third stereoscopic image detected on the right lens, and X_{LO,G1,G2} and X_{RO,G1,G2} means the influence of G2 to G1, which are measured on the left lens and right lens, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram schematically showing the configuration of an exemplary embodiment of a crosstalk measurement setup according to the present invention;

FIG. 2 is a block diagram showing the configuration of an exemplary embodiment of an apparatus for measuring 3D interocular crosstalk according to the present invention;

FIG. 3 is a diagram showing a table presenting an exemplary embodiment of residual luminance ratio term of LCD TV;

FIG. 4 is a diagram showing a graph presenting an exemplary embodiment of display's gamma characteristics;

FIG. 5 is a diagram showing a table presenting an exemplary embodiment of measured 3D interocular crosstalk of a LCD TV;

FIG. 6 is a diagram for explaining additive interocular crosstalk phenomenon;

FIG. 7 is a diagram for explaining subtractive interocular crosstalk phenomenon;

FIG. 8A to 8B are diagrams showing an exemplary embodiment of image pattern for measuring 3D interocular crosstalk in a gray mode;

FIG. 9 is a diagram showing an exemplary embodiment of side by side format of image pattern for measuring 3D interocular crosstalk in a gray mode;

FIG. 10 is a diagram showing an exemplary embodiment of top and bottom format of image pattern for measuring 3D interocular crosstalk in a gray mode;

FIG. 11A to 11B are diagrams showing an exemplary embodiment of image pattern for measuring 3D interocular crosstalk in a red color mode;

FIG. 12 is a diagram showing an exemplary embodiment of side by side format of image pattern for measuring 3D interocular crosstalk in a red color mode;

FIG. 13 is a diagram showing an exemplary embodiment of top and bottom format of image pattern for measuring 3D interocular crosstalk in a red color mode;

FIG. 14A to 14B are diagrams showing an exemplary embodiment of image pattern for measuring 3D interocular crosstalk in a green color mode;

FIG. 15 is a diagram showing an exemplary embodiment of side by side format of image pattern for measuring 3D interocular crosstalk in a green color mode;

FIG. 16 is a diagram showing an exemplary embodiment of top and bottom format of image pattern for measuring 3D interocular crosstalk in a green color mode;

FIG. 17A to 17B are diagrams showing an exemplary embodiment of image pattern for measuring 3D interocular crosstalk in a blue color mode;

FIG. 18 is a diagram showing an exemplary embodiment of side by side format of image pattern for measuring 3D interocular crosstalk in a blue color mode;

FIG. 19 is a diagram showing an exemplary embodiment of top and bottom format of image pattern for measuring 3D interocular crosstalk in a blue color mode;

FIG. 20 is a flowchart illustrating an exemplary embodiment of a method for measuring 3D interocular crosstalk according to the present invention;

FIG. 21 is a diagram for explaining a method for measuring 3D interocular crosstalk according to the present invention; and

FIG. 22 is a diagram showing a table presenting 3D interocular crosstalk measurement report.

### DETAILED DESCRIPTION OF THE INVENTION

Reference will now be made in detail to embodiments of the present disclosure, examples of which are illustrated in the accompanying drawings. Wherever possible, the same reference numbers will be used throughout the drawings to refer to the same or like parts.

Hereinafter, the exemplary embodiments of the present disclosure will be described with reference to the accompanying drawings. The configuration and action of the present disclosure shown in the drawings and described with reference to the drawings will be described as at least one embodiment; however, the technical idea and the core configuration and action of the present disclosure are not limited thereto.

Although the terms used in the present disclosure are selected from generally known and widely used terms in consideration of function in the present disclosure, terms used herein may be varied depending on operator's intention or customs in the art, emergence new technology, or the like. Also, some of the terms mentioned in the description of the present disclosure have been selected by the applicant at his or her discretion, the detailed meanings of which are described in relevant parts of the description herein. Therefore, the terms used in the present disclosure should be defined not based on the names of the terms but based on the meanings of the terms and the detailed description of the present disclosure.

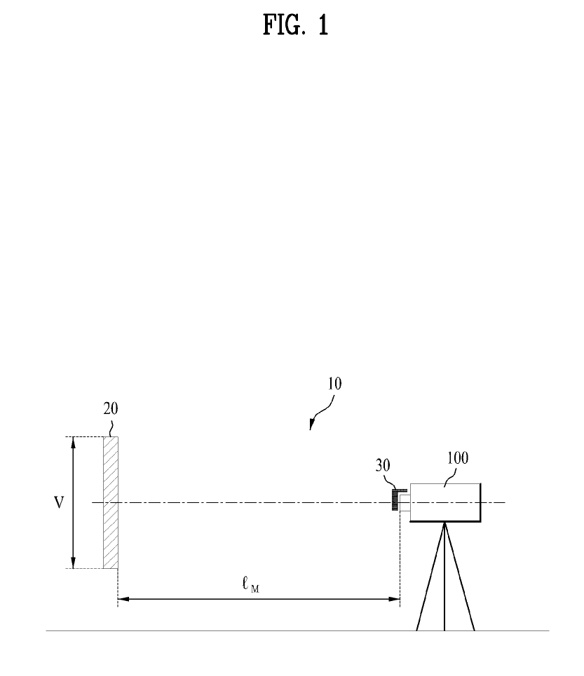

FIG. 1 is a diagram schematically showing the configuration of an exemplary embodiment of a crosstalk measurement setup according to the present invention.

Referring to FIG. 1, the crosstalk measurement system 10 according to the present invention may include a display 20, 3-dimensional (3D) Glasses 30 and a crosstalk measurement device 100. The crosstalk measurement system 10 may measure the characteristics of the display 20.

The display 20 may be a stereoscopic display. The display 20 may process a stereoscopic image and display the stereoscopic image in the glass method. The stereoscopic image may be output from the crosstalk measurement device 100.

The 3D Glasses 30 may include at least one of polarized glasses or shutter glasses. The 3D Glasses 30 separates a stereoscopic image presented in the display 20 into a left image and a right image. The left image and the right image passing from the 3D Glasses 30 are entered to the crosstalk measurement device 100.

The crosstalk measurement device 100 may be an apparatus for measuring 3D interocular crosstalk according to the present invention.

The distance l_{M} between the display 20 and the crosstalk measurement device 100 may be determined based on the viewing distance of the display 20. Also, the distance l_{M} may be determined based on the height V of the display 20.

The crosstalk measurement device 100 may locate at the front of the display 20. The 3D glasses may be placed between the display 20 and the crosstalk measurement device 100 and locate near to the crosstalk measurement device 100.

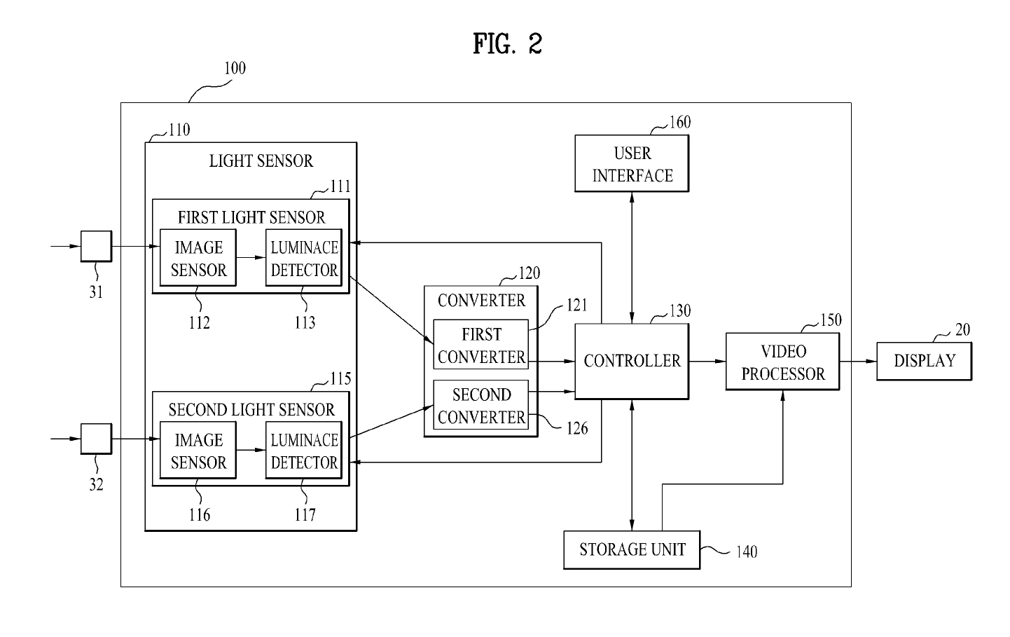

FIG. 2 is a block diagram showing the configuration of an exemplary embodiment of an apparatus for measuring 3D interocular crosstalk according to the present invention.

Referring to FIG. 2, the crosstalk measurement device 100 according to the present invention may include a light sensor 110, an analog-to-digital (A/D) converter 120, a controller 130, a storage unit 140, a video processor 150 and a user interface 160.

The light sensor 110 may be detect luminance of an image passing the 3D glasses and output an analog luminance signal. The image may be presented in the display 20. The light sensor 110 may include an image sensor 112, 116 and a luminance detector 113, 117. The image sensor 112, 116 may detect luminance of an image passing the 3D glasses and output a sensor output signal including information about the luminance. The image sensor 112, 116 may be a Charge Coupled Device (CCD) image sensor.

The luminance detector 113, 117 may detect luminance information included in the sensor output signal and may generate the analog luminance signal representative of the detected luminance information.

The light sensor 110 may include a first light sensor 111 and a second light sensor 115. The first light sensor 111 may detect luminance of a left image passing the left lens of the 3D glasses 30. The second light sensor 115 may detect luminance of a right image passing the right lens of the 3D glasses 30.

The A/D converter 120 may be used to convert the signals from the light sensor 110. The A/D converter 120 may convert the analog luminance signal to a digital form to generate a digital luminance signal representative of the detected luminance information. The A/D converter 120 may include a first A/D converter 121 for converting the signals from the first light sensor 111 and a second A/D converter 126 for converting the signals from the second light sensor 115.

The controller 130 may calculate an interocular crosstalk based on a luminance value. The luminance value may be the luminance value of an image passing the 3D glasses and the value of the luminance detected by the light sensor 110. The luminance value may be indicated by the digital luminance signal from A/D converter 120.

The controller 130 may generates at least one of measured interocular crosstalk values of each gray pairs (G1, G2), an average value of additive and subtractive interocular crosstalk or a peak value of additive and subtractive interocular crosstalk.

The controller 130 may control image patterns for measuring 3D interocular crosstalk to be displayed in a display 20. The image pattern displayed in a display 20 may be selected according to a display mode. The image pattern displayed in a display 20 may be changed according to the change of the display mode. The display mode may include at least one of a gray mode or a color mode. The color mode may include a red color mode, a green color mode or a blue color mode.

The controller 130 may generate 3D interocular crosstalk measurement report. The controller 130 may generate 3D interocular crosstalk measurement report for every display mode. The 3D interocular crosstalk measurement report may include at least one of measured interocular crosstalk values of each gray pairs (G1, G2), an average value of additive and subtractive interocular crosstalk or a peak value of additive and subtractive interocular crosstalk.

The controller 130 may execute commands and performs operation related to the crosstalk measurement device 100. For example, the controller 130 may control input and output between components of the crosstalk measurement device 100 and reception and processing of data, using the commands searched from the storage unit 140. The controller 130 may be implemented on a single chip, a plurality of chips, or a plurality of electric elements. For example, a dedicated or embedded processor, a single purpose processor, a controller, an ASIC, etc. may be used for the controller 130. The controller 130 may include at least one processor.

The controller 130 may detect a user action and control the crosstalk measurement device 100 based on the detected user action. The user action may include selection of a physical button of the crosstalk measurement device 100 or a remote controller, implementation of a prescribed touch gesture or selection of a soft button on a touch screen display, implementation of a prescribed spatial gesture recognized from an image captured from a capture device, and implementation of prescribed speaking recognized through voice recognition with respect to a voice signal received by a sound sensor. The controller 130 may interpret the user action as at least one implementable command. The controller 130 may control the components of the crosstalk measurement device 100 in response to the at least one interpreted command. That is, the controller 130 may control input and output between the components of the crosstalk measurement device 100 and reception and processing of data, using the at least one command.

The controller 130 may execute computer code together with an Operating System (OS) and generates and uses data. The OS is generally known and a detailed description thereof will not be given. For example, the OS may be a Windows series OS, UNIX, Linux, Palm OS, DOS, Android, and Mac OS. The OS, other computer code, and data may be included in the storage unit 140 which operates in association with the controller 130.

The storage unit 140 may store image patterns for measuring 3D interocular crosstalk.

The storage unit 140 generally provides a place for storing program code and data used by the crosstalk measurement device 100. For example, the storage unit 140 may be implemented as a Read Only Memory (ROM), a Random Access Memory (RAM), or a hard disk drive. The program code and data may be stored in a removable storage medium and, if necessary, may be loaded to or installed in the crosstalk measurement device 100. The removable storage medium includes a CD-ROM, PC card, a memory card, a floppy disc, a magnetic tape, or a network component.

The video processor 150 may process a video signal and output to the processed video signal to a display. The display may be the display 20. The display may include a PDP TV and a LCD TV.

The user interface 160 may be receives a user action and output the received user action to the controller 130.

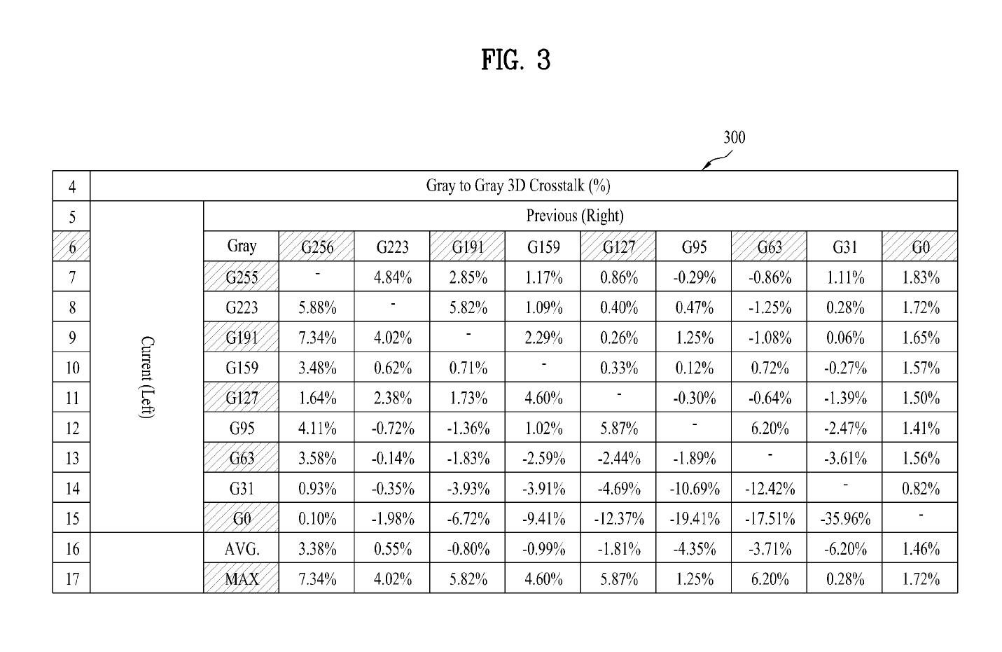

FIG. 3 is a diagram showing a table presenting an exemplary embodiment of residual luminance ratio term of LCD TV.

Referring to FIG. 3, the controller 130 may calculate an interocular crosstalk by the following equation 1 or the following equation 2.

$$\begin{matrix}{X}_{LO , G 1 , G 2} = ( {( \frac{G 2}{255} )}^{γ} - {( \frac{G 1}{255} )}^{γ} ) \times \frac{{L}_{LO , G 1 , G 2} - {L}_{LO , G 2 , G 2}}{{L}_{LO , G 2 , G 1} - {L}_{LO , G 2 , G 2}} \times 100 \% & Equation 1 \\ {X}_{RO , G 1 , G 2} = ( {( \frac{G 2}{255} )}^{γ} - {( \frac{G 1}{255} )}^{γ} ) \times \frac{{L}_{RO , G 1 , G 2} - {L}_{RO , G 2 , G 2}}{{L}_{RO , G 2 , G 1} - {L}_{RO , G 2 , G 2}} \times 100 \% & Equation 2\end{matrix}$$

In the above equation 1 and 2, 3D interocular X_{LO,G1,G2} and X_{RO,G1,G2} means the influence of unobserved gray level G2 to the observed gray level G1, which are measured on the left and right lenses, respectively. G1 and G2 may be a value between a minimum gray value and a maximum gray value. In some embodiments, the minimum gray level may be 0 and the maximum gray level may be 255.

L_{LO,G1,G2} is a luminance value observed on the left lenses of 3D glasses 30, when the observed side's gray levels is G1 and the unobserved side's gray level is G2. L_{RO,G1,G2} is a luminance value observed on the right lenses of 3D glasses, when the observed side's gray level is G1 and the unobserved side's gray level is G2.

Γ is a display's γ value, which may be set to a specific one for the optimum performance.

The negative and positive signs of measured 3D crosstalk mean additive and subtractive crosstalk, respectively. The negative and positive values may be specified in the measurement report.

The equation 1 and 2 contain a gray-difference term and a residual luminance ratio term. The gray-difference term is

$$( {( \frac{G 2}{255} )}^{γ} - {( \frac{G 1}{255} )}^{γ} )$$

and the residual luminance ratio term is

$$\frac{{L}_{LO , G 1 , G 2} - {L}_{LO , G 2 , G 2}}{{L}_{LO , G 2 , G 1} - {L}_{LO , G 2 , G 2}} \times 100 \% and \frac{{L}_{RO , G 1 , G 2} - {L}_{RO , G 2 , G 2}}{{L}_{RO , G 2 , G 1} - {L}_{RO , G 2 , G 2}} \times 100 \%$$

Denominator (L_{LO/RO,G1,G2}−L_{LO/RO,G2,G2}) of the residual luminance ratio term is the difference of original luminance, gray G1 and gray G2. Numerator (L_{LO/RO,G2,G1}−L_{LO/RO,G2,G2}) of the residual luminance ratio term is the difference of residual luminance, gray G1 and gray G2.

A table 300 shown in the FIG. 3 presents an example of measured residual luminance ratio term of a LCD TV. In table 300, there are cases in which the measured residual luminance ratio is large when the difference of gray levels, G1 and G2, is small. For an example, when G1=G127 and G2=G159, the measured residual luminance ratio is 4.60% and when G1=G127 and G2=G223, the measured residual luminance ratio is 2.38%.

When the residual luminance ratio of some 3D TV sets is measured, it could not explain the Gray-to-Gray (G2G) 3D crosstalk phenomenon quantitatively. A user may feel 3D interocular crosstalk more severely when the difference of gray levels, G1 and G2, was large. However, the measured residual luminance ratio was large when the difference of gray levels, G1 and G2, was small. Therefore other terms in the gray to gray condition is proposed in the present invention.

When the difference of gray levels, G1 and G2, increases, the crosstalk phenomenon may be observed more severely. So, the present invention proposes the gray difference term, which is multiplied by residual luminance ratio term to calculate 3D interocular crosstalk.

The suggested gray difference term is based on the display's gamma value, which represents displayed image's characteristics.

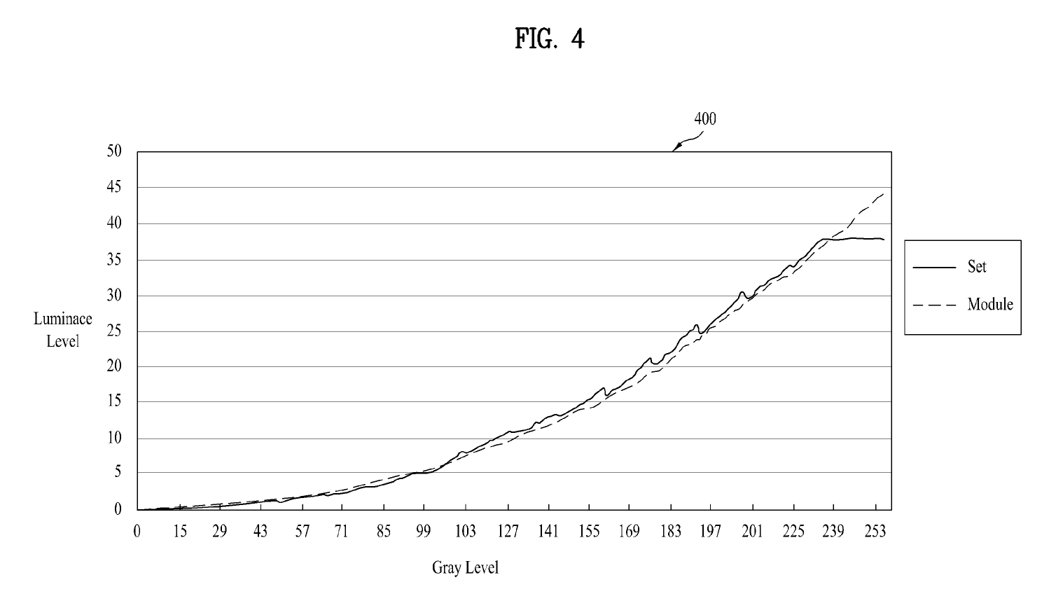

FIG. 4 is a diagram showing a graph presenting an exemplary embodiment of display's gamma characteristics.

Referring to FIG. 4, a graph 400 presents an example of display's gamma characteristics. The display's luminance has non-linear characteristics depending on input gray levels, as shown in the graph 400. The brightness level of the input gray level may be changed according to the change of the display's gamma value.

Therefore, by calculating 3D interocular crosstalk based on display's gamma, the present invention can reflect output characteristics accurately in calculating 3D interocular crosstalk and can calculate 3D interocular crosstalk adaptively according to the type of a display.

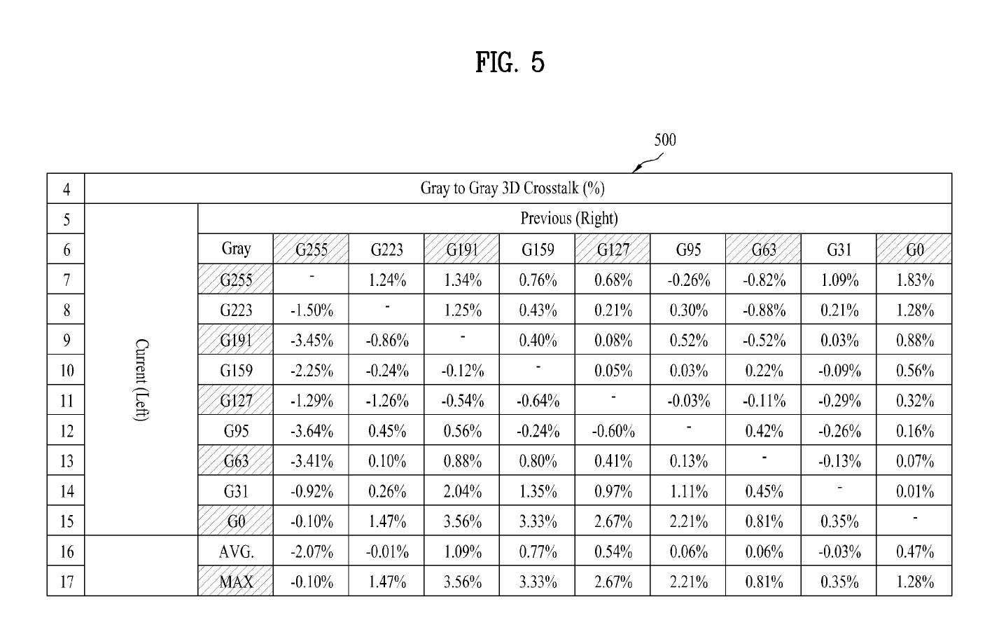

FIG. 5 is a diagram showing a table presenting an exemplary embodiment of measured 3D interocular crosstalk of a LCD TV.

Referring to FIG. 5, a table 500 represents an example of measured 3D crosstalk of a LCD TV using the equation 1. There are additive interocular crosstalk and subtractive interocular crosstalk as shown in the table 500.

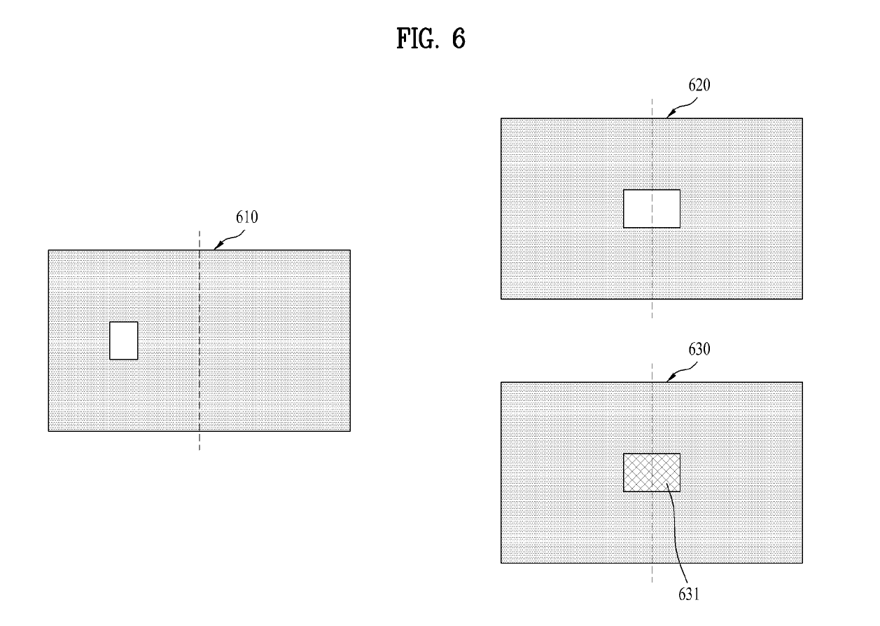

FIG. 6 is a diagram for explaining additive interocular crosstalk phenomenon.

Referring to FIG. 6, the additive interocular crosstalk occurs when the observed luminance L_{LO/RO,G1,G2} is larger than that of both eye's condition L_{LO/RO,G2,G2}, which increases image's gray level where it occurs as shown in FIG. 6. An image 610 is a stereoscopic image with a side by side format. When the stereoscopic image 610 is displayed in the display 20, an image 620 is a left observed image of the displayed stereoscopic image 610 and an image 630 is a right observed image of the displayed stereoscopic image 610. The additive interocular crosstalk 631 occurs in the right observed image 630.

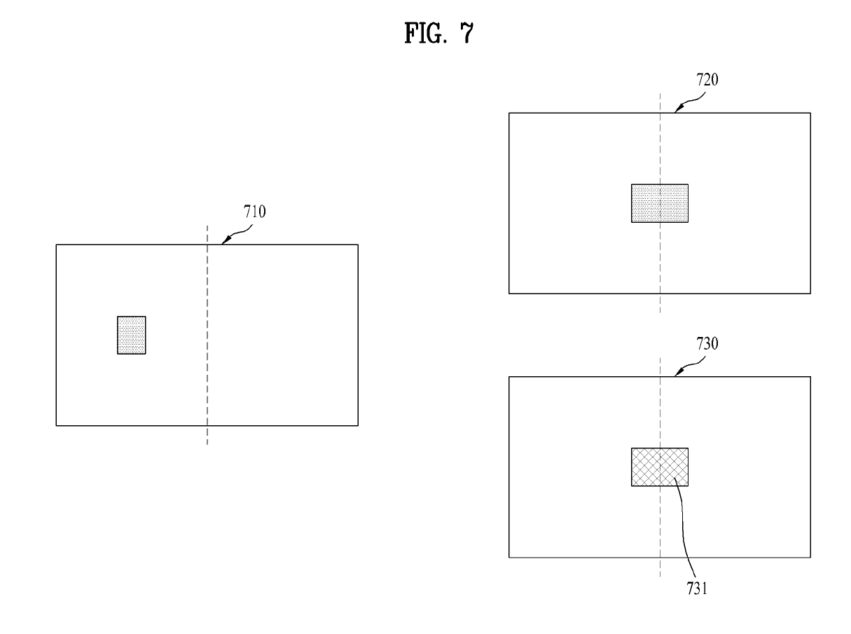

FIG. 7 is a diagram for explaining subtractive interocular crosstalk phenomenon.

Referring to FIG. 7, the subtractive interocular crosstalk occurs when the observed luminance L_{LO/RO,G1,G2} is smaller than that of both eye's condition L_{LO/RO,G2,G2}, which decreases image's gray level where it occurs as shown in FIG. 6.

An image 710 is a stereoscopic image with a side by side format. When the stereoscopic image 710 is displayed in the display 20, an image 720 is a left observed image of the displayed stereoscopic image 710 and an image 730 is a right observed image of the displayed stereoscopic image 710. The subtractive interocular crosstalk 731 occurs in the right observed image 730.

Conventional interocular crosstalk formula only considers additive case. The present invention may include subtractive interocular crosstalk case as well as additive interocular crosstalk case.

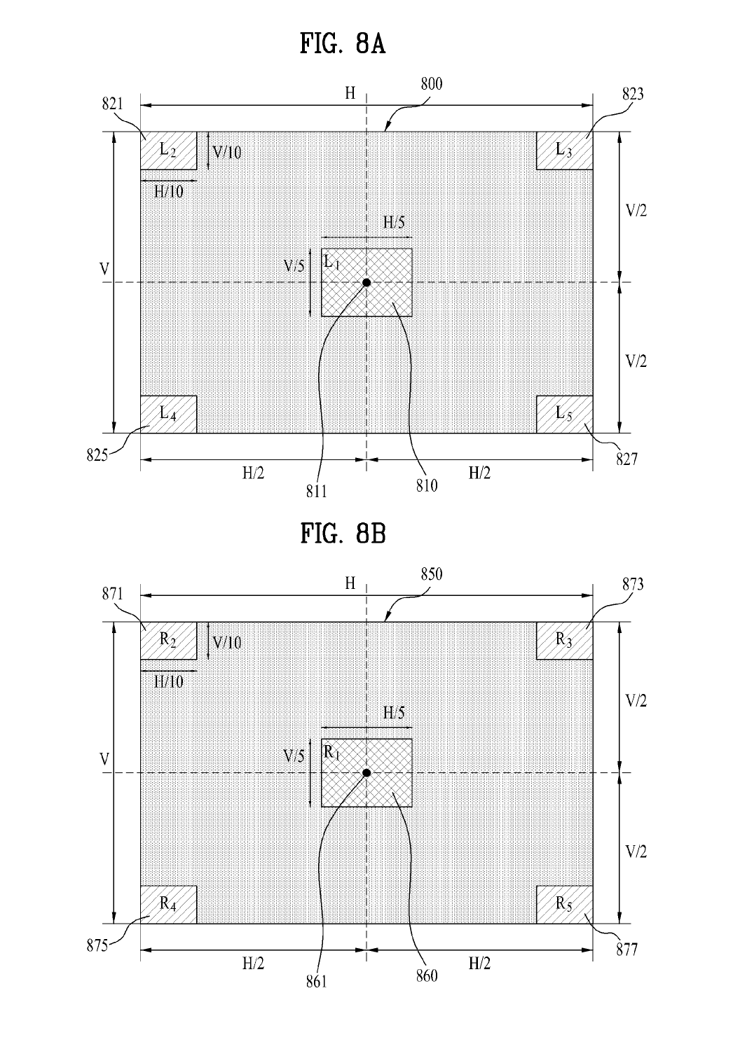

FIG. 8A to 8B are diagrams showing an exemplary embodiment of image pattern for measuring 3D interocular crosstalk in a gray mode.

Referring to FIG. 8A to 8B, the present invention provides the image pattern for measuring 3D interocular crosstalk. The image pattern may be stored in the storage unit 140 and processed by the video processor 150 and displayed in the display 20. Hereinafter, the image pattern for measuring 3D interocular crosstalk is named as a measurement pattern.

The measurement pattern of the present invention may be characterized in that a condition in which all pairs of interocular crosstalk should be measured at the same Average Picture Level (APL) condition is satisfied.

The measurement pattern of the present invention may be characterized in that a condition in which both a LCD TV and a PDP TV control display brightness depending on APL is satisfied.

The measurement pattern of the present invention may be characterized in that a condition in which as the APL of measurement pattern varies, the interocular crosstalk value changes is satisfied.

The measurement pattern of the present invention may be characterized in that a condition in which left and right images have the same APL is satisfied.

As an exemplary embodiment of the measurement pattern of the present invention, both left and right images of the measurement pattern include one 4% sized window box and four 1% sized window boxes.

The four 1% sized window boxes may be set to keep the APL of measurement pattern constant. In some embodiments, The sum of gray level of the 4% sized window box and the four 1% sized window box may be set to 255(max. gray level).

For an example, if the gray level of the 4% sized window box is 100, the gray level of each 1% sized window box is set to 155.

The luminance for measuring 3D interocular crosstalk is measured at the screen center. The center of the 4% sized window box may be placed at the screen center.

An image pattern 800 shown in the FIG. 8A may be the measurement pattern for measuring L_{LO,G1,G2} of the gray mode and may be a left image of a stereoscopic image. The image pattern 800 includes a 4% sized window box 810 and a four 1% sized window boxes 821, 823, 825, 827.

The center 811 of the 4% sized window box 810 may be placed at the screen center. The gray level of the 4% sized window box 810 is a gray level (G1, G1, G1). Hereinafter, Gray level (G1, G2, G3) means red gray level of G1, green gray level of G2, blue gray level of G3. G1, G2 and G3 may be a value between a minimum gray value and a maximum gray value.

The four 1% sized window boxes 821, 823, 825, 827 are placed in the corner of the screen. The 1% sized window 821 is located at the up-left of the screen and the 1% sized window 823 is located at the up-right of the screen. The 1% sized window 825 is located at the down-left of the screen and the 1% sized window 827 is located at the down-right of the screen. The gray levels of the four 1% sized window boxes 821, 823, 825, 827 are gray level (255−G1, 255−G1, 255−G1).

An image pattern 850 shown in the FIG. 8B may be the measurement pattern for measuring L_{RO,G1,G2} of the gray mode and may be a right image of a stereoscopic image. The image pattern 850 includes a 4% sized window box 860 and a four 1% sized window boxes 871, 873, 875, 877.

The center 861 of the 4% sized window box 860 may be placed at the screen center. The gray level of the 4% sized window box 860 is a gray level (G2, G2, G2).

The four 1% sized window boxes 871, 873, 875, 877 are placed in the corner of the screen. The 1% sized window 871 is located at the up-left of the screen and the 1% sized window 873 is located at the up-right of the screen. The 1% sized window 875 is located at the down-left of the screen and the 1% sized window 877 is located at the down-right of the screen. The gray levels of the four 1% sized window boxes 871, 873, 875, 877 are gray level (255−G2, 255−G2, 255−G2).

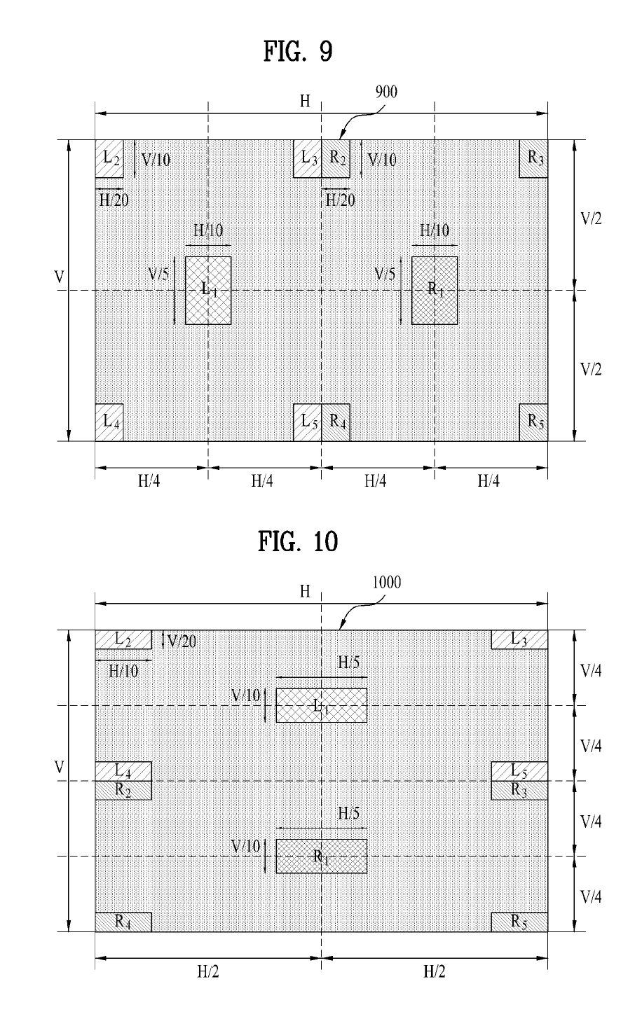

FIG. 9 is a diagram showing an exemplary embodiment of side by side format of image pattern for measuring 3D interocular crosstalk in a gray mode and FIG. 10 is a diagram showing an exemplary embodiment of top and bottom format of image pattern for measuring 3D interocular crosstalk in a gray mode.

Referring to FIG. 9 and FIG. 10, an image pattern 900 is a stereoscopic image with a side by side format for the image pattern 800 and the image pattern 850. An image pattern 1000 is a stereoscopic image with a top and bottom format for the image pattern 800 and the image pattern 850.

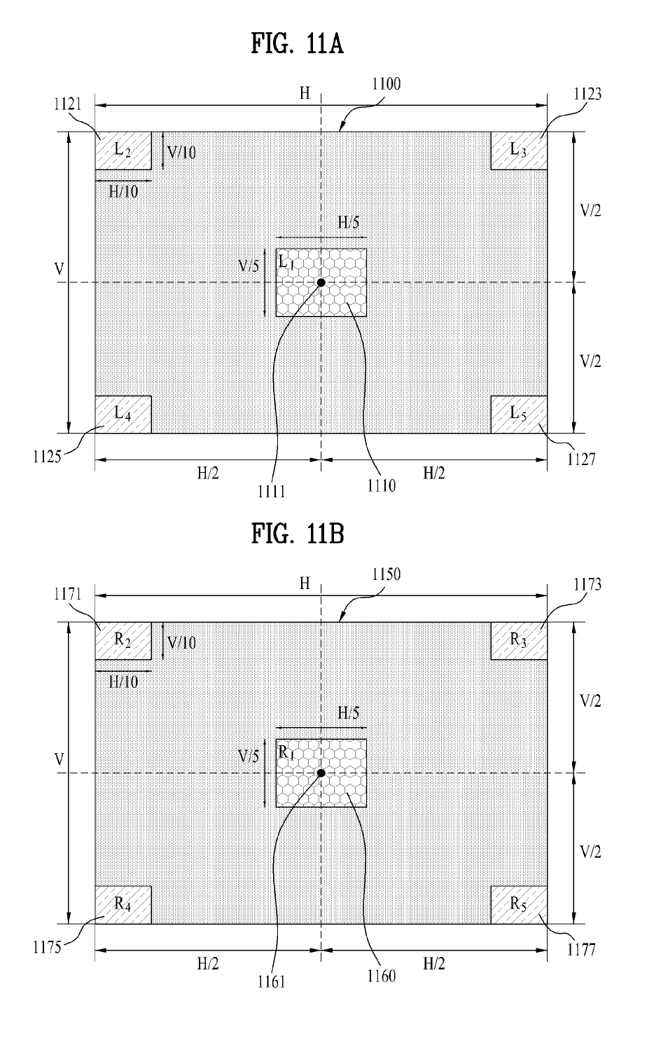

FIG. 11A to 11B are diagrams showing an exemplary embodiment of image pattern for measuring 3D interocular crosstalk in a red color mode.

Referring to FIG. 11A to 11B, an image pattern 1100 may be the measurement pattern for measuring L_{LO,G1,G2} of the red color mode and a left image of a stereoscopic image. The image pattern 1100 includes a 4% sized window box 1110 and a four 1% sized window boxes 1121, 1123, 1125, 1127.

The center 1111 of the 4% sized window box 1110 may be placed at the screen center. The gray level of the 4% sized window box 1110 is a gray level (G1, 0, 0).

The four 1% sized window boxes 1121, 1123, 1125, 1127 are placed in the corner of the screen. The 1% sized window 1121 is located at the up-left of the screen and the 1% sized window 1123 is located at the up-right of the screen. The 1% sized window 1125 is located at the down-left of the screen and the 1% sized window 1127 is located at the down-right of the screen. The gray levels of the four 1% sized window boxes 1121, 1123, 1125, 1127 are gray level (255−G1, 255, 255).

An image pattern 1150 may be the measurement pattern for measuring L_{RO,G1,G2} of the red color mode and a right image of a stereoscopic image. The image pattern 1150 includes a 4% sized window box 1160 and a four 1% sized window boxes 1171, 1173, 1175, 1177.

The center 1161 of the 4% sized window box 1160 may be placed at the screen center. The gray level of the 4% sized window box 1160 is a gray level (G2, 0, 0).

The four 1% sized window boxes 1171, 1173, 1175, 1177 are placed in the corner of the screen. The 1% sized window 1171 is located at the up-left of the screen and the 1% sized window 1173 is located at the up-right of the screen. The 1% sized window 1175 is located at the down-left of the screen and the 1% sized window 1177 is located at the down-right of the screen. The gray levels of the four 1% sized window boxes 1171, 1173, 1175, 1177 are gray level (255−G2, 255, 255).

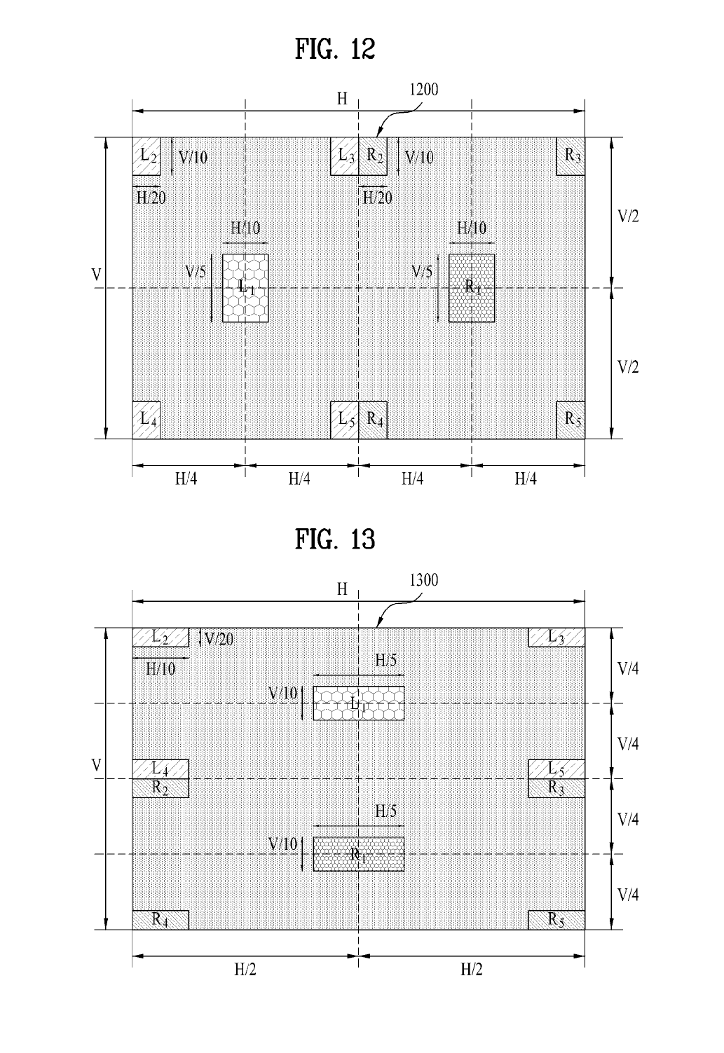

FIG. 12 is a diagram showing an exemplary embodiment of side by side format of image pattern for measuring 3D interocular crosstalk in a red color mode and FIG. 13 is a diagram showing an exemplary embodiment of top and bottom format of image pattern for measuring 3D interocular crosstalk in a red color mode.

Referring to FIG. 12 and FIG. 13, an image pattern 1200 is a stereoscopic image with a side by side format for the image pattern 1100 and the image pattern 1150. An image pattern 1300 is a stereoscopic image with a top and bottom format for the image pattern 1100 and the image pattern 1150.

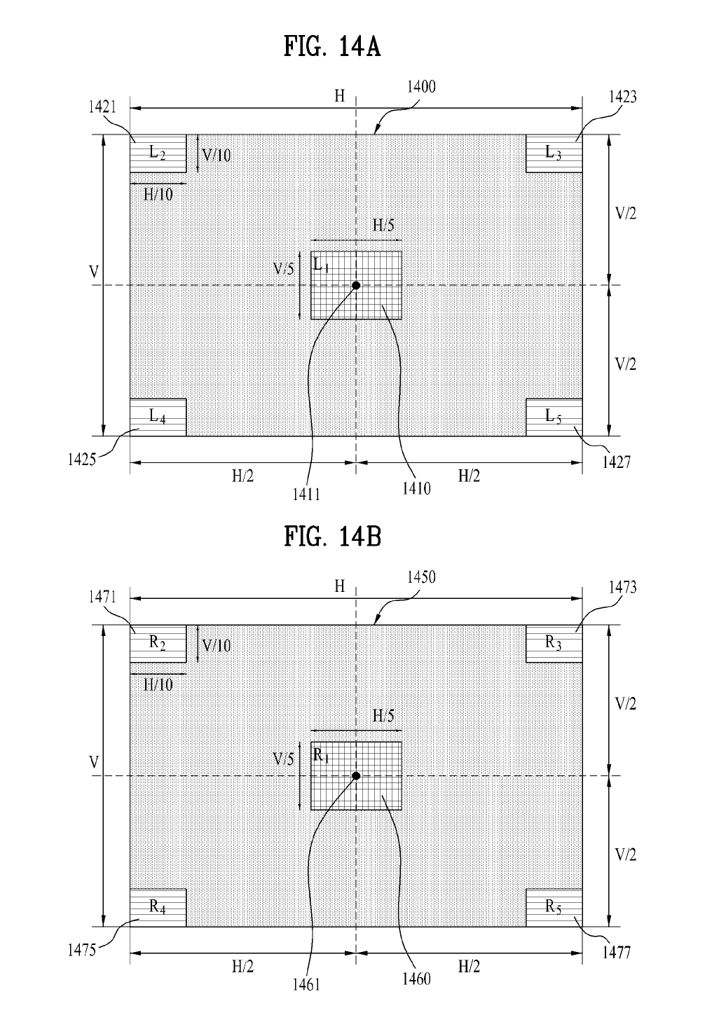

FIG. 14A to 14B are diagrams showing an exemplary embodiment of image pattern for measuring 3D interocular crosstalk in a green color mode.

Referring to FIG. 14A to 14B, an image pattern 1400 may be the measurement pattern for measuring L_{LO,G1,G2} of the green color mode and a left image of a stereoscopic image. The image pattern 1400 includes a 4% sized window box 1410 and a four 1% sized window boxes 1421, 1423, 1425, 1427.

The center 1411 of the 4% sized window box 1410 may be placed at the screen center. The gray level of the 4% sized window box 1410 is a gray level (0, G1, 0).

The four 1% sized window boxes 1421, 1423, 1425, 1427 are placed in the corner of the screen. The 1% sized window 1421 is located at the up-left of the screen and the 1% sized window 1423 is located at the up-right of the screen. The 1% sized window 1425 is located at the down-left of the screen and the 1% sized window 1427 is located at the down-right of the screen. The gray levels of the four 1% sized window boxes 1421, 1423, 1425, 1427 are gray level (255, 255−G1, 255).

An image pattern 1450 may be the measurement pattern for measuring L_{RO,G1,G2} of the green color mode and a right image of a stereoscopic image. The image pattern 1450 includes a 4% sized window box 1460 and a four 1% sized window boxes 1471, 1473, 1475, 1477.

The center 1461 of the 4% sized window box 1460 may be placed at the screen center. The gray level of the 4% sized window box 1460 is a gray level (0, G2, 0).

The four 1% sized window boxes 1471, 1473, 1475, 1477 are placed in the corner of the screen. The 1% sized window 1471 is located at the up-left of the screen and the 1% sized window 1473 is located at the up-right of the screen. The 1% sized window 1475 is located at the down-left of the screen and the 1% sized window 1477 is located at the down-right of the screen. The gray levels of the four 1% sized window boxes 1471, 1473, 1475, 1477 are gray level (255, 255−G2, 255).

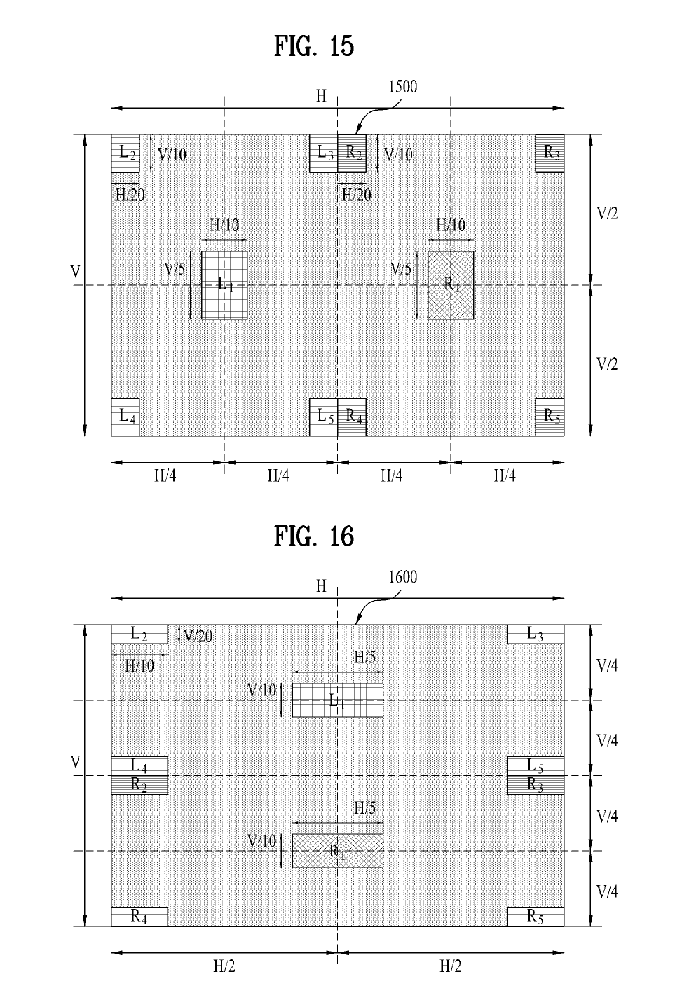

FIG. 15 is a diagram showing an exemplary embodiment of side by side format of image pattern for measuring 3D interocular crosstalk in a green color mode and FIG. 16 is a diagram showing an exemplary embodiment of top and bottom format of image pattern for measuring 3D interocular crosstalk in a green color mode.

Referring to FIG. 15 and FIG. 16, an image pattern 1500 is a stereoscopic image with a side by side format for the image pattern 1400 and the image pattern 1450. An image pattern 1600 is a stereoscopic image with a top and bottom format for the image pattern 1400 and the image pattern 1450.

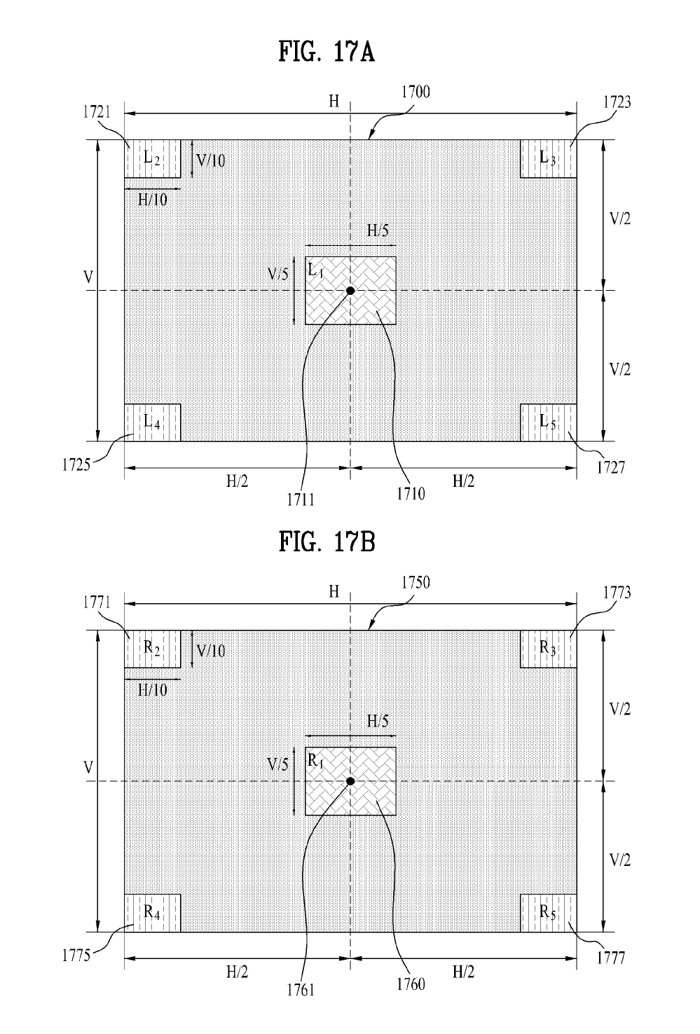

FIG. 17A to 17B are diagrams showing an exemplary embodiment of image pattern for measuring 3D interocular crosstalk in a blue color mode.

Referring to FIG. 17, an image pattern 1700 may be the measurement pattern for measuring L_{LO,G1,G2} of the blue color mode and a left image of a stereoscopic image. The image pattern 1700 includes a 4% sized window box 1710 and a four 1% sized window boxes 1721, 1723, 1725, 1727.

The center 1411 of the 4% sized window box 1710 may be placed at the screen center. The gray level of the 4% sized window box 1710 is a gray level (0, 0, G1).

The four 1% sized window boxes 1721, 1723, 1725, 1727 are placed in the corner of the screen. The 1% sized window 1721 is located at the up-left of the screen and the 1% sized window 1723 is located at the up-right of the screen. The 1% sized window 1725 is located at the down-left of the screen and the 1% sized window 1727 is located at the down-right of the screen. The gray levels of the four 1% sized window boxes 1721, 1723, 1725, 1727 are gray level (255, 255, 255−G1).

An image pattern 1750 may be the measurement pattern for measuring L_{RO,G1,G2} of the blue color mode and a right image of a stereoscopic image. The image pattern 1750 includes a 4% sized window box 1760 and a four 1% sized window boxes 1771, 1773, 1775, 1777.

The center 1761 of the 4% sized window box 1760 may be placed at the screen center. The gray level of the 4% sized window box 1760 is a gray level (0, 0, G2).

The four 1% sized window boxes 1771, 1773, 1775, 1777 are placed in the corner of the screen. The 1% sized window 1771 is located at the up-left of the screen and the 1% sized window 1773 is located at the up-right of the screen. The 1% sized window 1775 is located at the down-left of the screen and the 1% sized window 1777 is located at the down-right of the screen. The gray levels of the four 1% sized window boxes 1771, 1773, 1775, 1777 are gray level (255, 255, 255−G2).

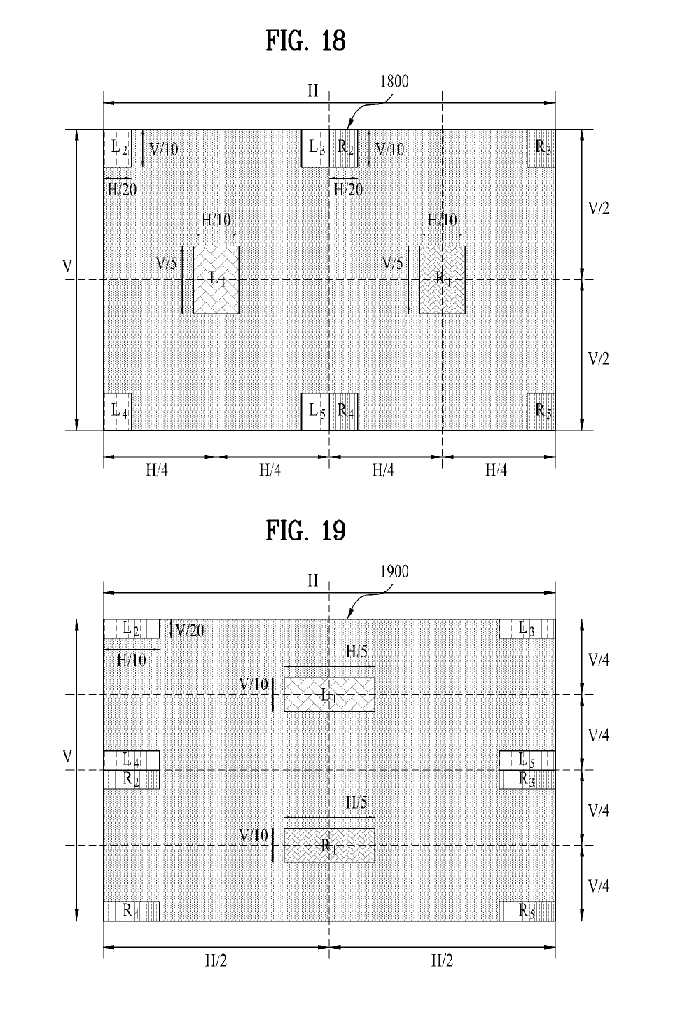

FIG. 18 is a diagram showing an exemplary embodiment of side by side format of image pattern for measuring 3D interocular crosstalk in a blue color mode and FIG. 19 is a diagram showing an exemplary embodiment of top and bottom format of image pattern for measuring 3D interocular crosstalk in a blue color mode.

Referring to FIG. 18 and FIG. 19, an image pattern 1800 is a stereoscopic image with a side by side format for the image pattern 1700 and the image pattern 1750. An image pattern 1900 is a stereoscopic image with a top and bottom format for the image pattern 1700 and the image pattern 1750.

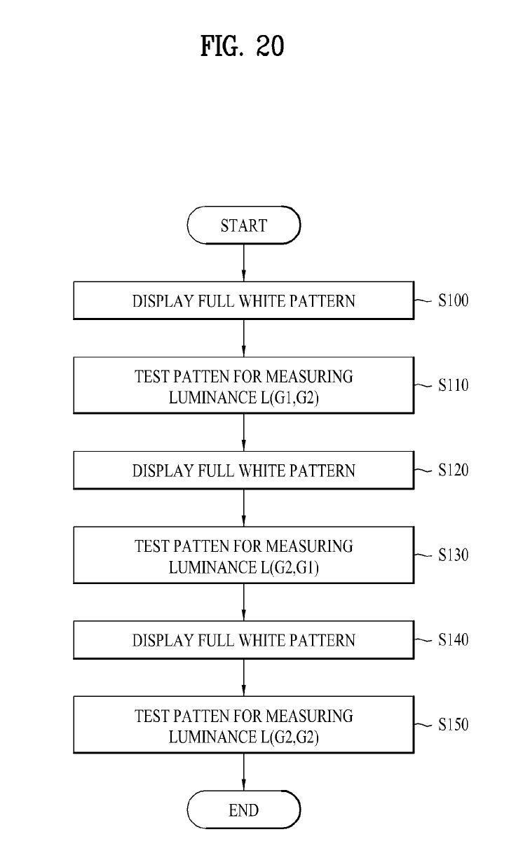

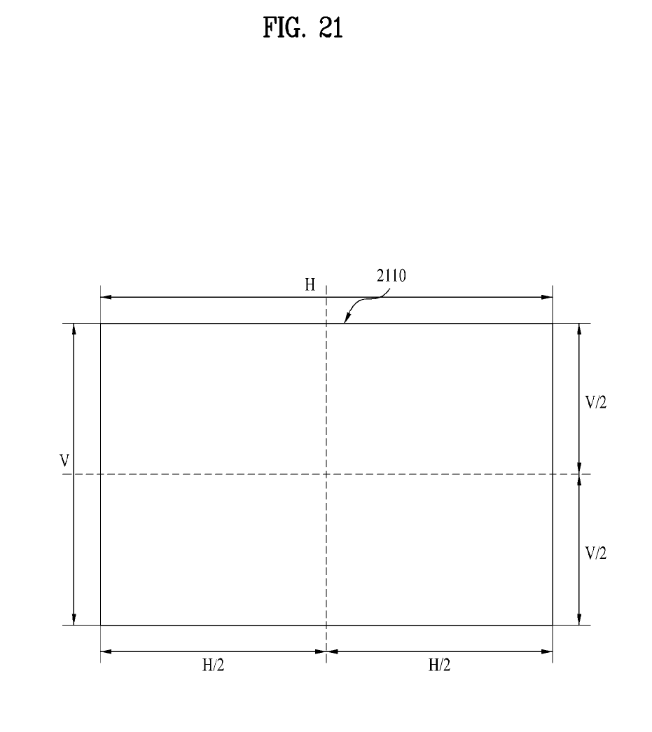

FIG. 20 is a flowchart illustrating an exemplary embodiment of a method for measuring 3D interocular crosstalk according to the present invention and FIG. 21 is a diagram for explaining a method for measuring 3D interocular crosstalk according to the present invention.

Referring to FIG. 20 and FIG. 21. The display 20 may display an image pattern 2110, in step S100. The image pattern 2110 is for reducing measurement error caused by image sticking. The image pattern 2110 may be 100% sized full white pattern.

The crosstalk measurement device 100 may output the image pattern 2110 to the display 20, in the step S100. The display 20 may display the output image pattern 2110.

The display 20 may display a test pattern for measuring luminanceL (G1, G2), in step S110. The displayed test pattern may be one of the measurement pattern 800 shown in FIG. 8A, the measurement pattern 850 shown in FIG. 8B, the measurement pattern 1100 shown in FIG. 11A, the measurement pattern 1150 shown in FIG. 11B, the measurement pattern 1400 shown in FIG. 14A, the measurement pattern 1450 shown in FIG. 14B, the measurement pattern 1700 shown in FIG. 17A or the measurement pattern 1750 shown in FIG. 17B.

The crosstalk measurement device 100 may output the test pattern to the display 20, in the step S110. The display 20 may display the output test pattern.

The crosstalk measurement device 100 may detect luminance of the test pattern displayed in display 20, in the step s110. The crosstalk measurement device 100 generates a luminance value indicating the detected luminance of the text pattern.

The display 20 may display the image pattern 2110, in step S120. The image pattern 2110 is for reducing measurement error caused by image sticking.

The crosstalk measurement device 100 may output the image pattern 2110 to the display 20, in the step S120. The display 20 may display the output image pattern 2110.

The display 20 may display a test pattern for measuring luminanceL (G2, G1) in step S130. The displayed test pattern may be one of the measurement pattern 800 shown in FIG. 8A, the measurement pattern 850 shown in FIG. 8B, the measurement pattern 1100 shown in FIG. 11A, the measurement pattern 1150 shown in FIG. 11B, the measurement pattern 1400 shown in FIG. 14A, the measurement pattern 1450 shown in FIG. 14B, the measurement pattern 1700 shown in FIG. 17A or the measurement pattern 1750 shown in FIG. 17B.

The crosstalk measurement device 100 may output the test pattern to the display 20, in the step S130. The display 20 may display the output test pattern.

The crosstalk measurement device 100 may detect luminance of the test pattern displayed in display 20, in the step s130. The crosstalk measurement device 100 generates a luminance value indicating the detected luminance of the text pattern.

The display 20 may display the image pattern 2110, in step S140. The image pattern 2110 is for reducing measurement error caused by image sticking.

The crosstalk measurement device 100 may output the image pattern 2110 to the display 20, in the step S140. The display 20 may display the output image pattern 2110.

The display 20 may display a test pattern for measuring luminanceL (G2, G2) in step S150. The displayed test pattern may be one of the measurement pattern 800 shown in FIG. 8A, the measurement pattern 850 shown in FIG. 8B, the measurement pattern 1100 shown in FIG. 11A, the measurement pattern 1150 shown in FIG. 11B, the measurement pattern 1400 shown in FIG. 14A, the measurement pattern 1450 shown in FIG. 14B, the measurement pattern 1700 shown in FIG. 17A or the measurement pattern 1750 shown in FIG. 17B.

The crosstalk measurement device 100 may output the test pattern to the display 20, in the step S150. The display 20 may display the output test pattern.

The crosstalk measurement device 100 may detect luminance of the test pattern displayed in display 20, in the step s150. The crosstalk measurement device 100 generates a luminance value indicating the detected luminance of the text pattern.

The crosstalk measurement device 100 may calculate at least one of 3D interocular crosstalk X_{LO,G1,G2} or 3D interocular crosstalk X_{RO,G1,G2} using the luminance value generated in the step s110, the luminance value generated in the step s130 and the luminance value generated in the step s150.

The crosstalk measurement device 100 may calculate the 3D interocular crosstalk X_{LO,G1,G2} by the equation 1. The crosstalk measurement device 100 may calculate the 3D interocular crosstalk X_{RO,G1,G2} by the equation 2.

In some embodiments, the display 20 may display a test pattern for measuring luminanceL (G1, G1) in step S150. The crosstalk measurement device 100 may calculate at least one of 3D interocular crosstalk X_{LO,G1,G2} or 3D interocular crosstalk X_{RO,G1,G2} using the luminance value generated in the step s110, the luminance value generated in the step s130 and the luminance value indicating the detected luminance of the text pattern for measuring luminanceL (G1, G1). The crosstalk measurement device 100 may calculate the 3D interocular crosstalk X_{LO,G1,G2} by the following equation 3.

$${X}_{LO , G 1 , G 2} = ( {( \frac{G 2}{255} )}^{γ} - {( \frac{G 1}{255} )}^{γ} ) \times \frac{{L}_{LO , G 1 , G 2} - {L}_{LO , G 1 , G 1}}{{L}_{LO , G 2 , G 1} - {L}_{LO , G 1 , G 1}} \times 100 \% \qquad Equation 3$$

The crosstalk measurement device 100 may calculate the 3D interocular crosstalk X_{RO,G1,G2} by the following equation 4.

$${X}_{RO , G 1 , G 2} = ( {( \frac{G 2}{255} )}^{γ} - {( \frac{G 1}{255} )}^{γ} ) \times \frac{{L}_{RO , G 1 , G 2} - {L}_{RO , G 1 , G 1}}{{L}_{RO , G 2 , G 1} - {L}_{RO , G 1 , G 1}} \times 100 \% \qquad Equation 4$$

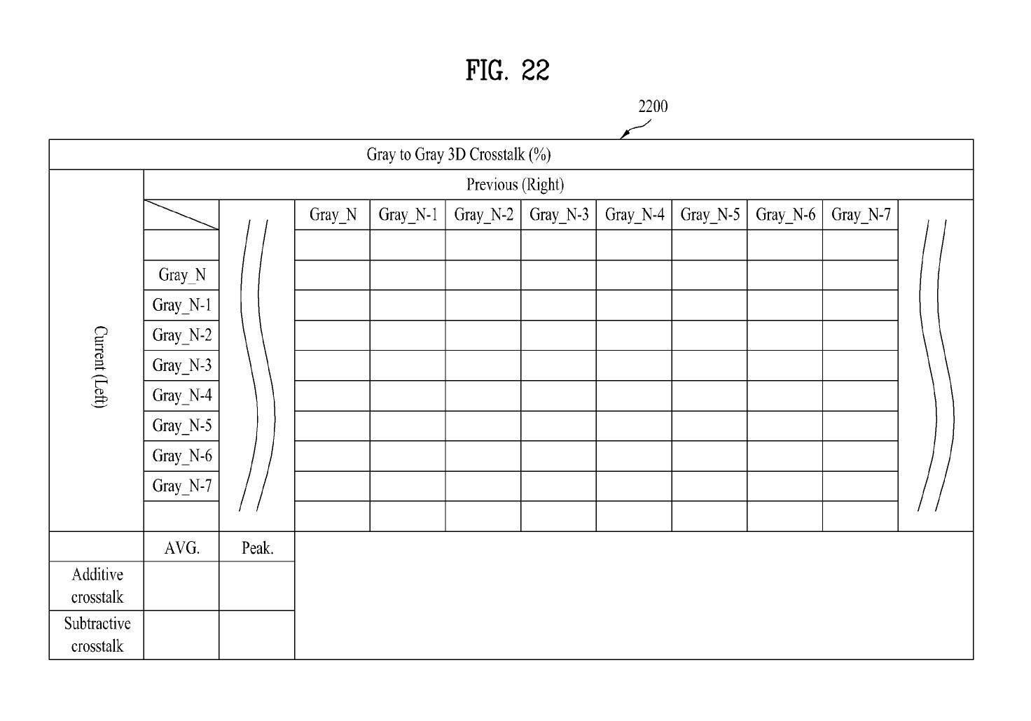

FIG. 22 is a diagram showing the table presenting 3D interocular crosstalk measurement report.

Referring to FIG. 22, the interocular crosstalk measurement report according to the present invention may have a table type 2200. The controller 130 may generate 3D interocular crosstalk measurement report table 2200 for every display mode.

The interocular crosstalk measurement report table 2200 may includes at least one of measured interocular crosstalk values of each gray pairs (G1, G2), an average value of additive and subtractive interocular crosstalk or a peak value of additive and subtractive interocular crosstalk.

As broadly described and embodied herein, the apparatus and the method for measuring 3D interocular crosstalk provides a measurement pattern of the gray mode or the color mode and measures 3D interocular crosstalk using the measurement pattern, and therefore, it is possible to measure 3D interocular crosstalk considering pixel distribution of real video contents and G2G conditions.

The apparatus and the method for measuring 3D interocular crosstalk calculate 3D interocular crosstalk based on display's gamma. Hence, the present invention can reflect output characteristics accurately in calculating 3D interocular crosstalk and can calculate 3D interocular crosstalk adaptively according to the type of a display.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for measuring 3-dimensional (3D) interocular crosstalk, comprising:
a light sensor configured to detect luminance of a stereoscopic image displayed in a display and output a luminance value indicating the detected luminance; and
a controller configured to calculate 3D interocular crosstalk based on a gray difference and a residual luminance ratio, wherein the gray difference is calculated based on gray levels of a first view image and a second view image included in the stereoscopic image and the residual luminance ratio is calculated based on the luminance value.

2. The apparatus according to claim 1, wherein the stereoscopic image is displayed in a glasses method or a non-glasses method.

3. The apparatus according to claim 1, wherein the light sensor detects luminance of the stereoscopic image passing 3D glasses.

4. The apparatus according to claim 1, wherein the gray difference is multiplied by the residual luminance ratio to calculate the 3D interocular crosstalk.

5. The apparatus according to claim 1, wherein the gray difference is calculated further based on the display's Gamma (γ) value.

6. The apparatus according to claim 1, wherein the gray difference is calculated by the following equation (1),
$${D}_{G 1 , G 2} = {( \frac{G 2}{255} )}^{γ} - {( \frac{G 1}{255} )}^{γ}$$
The following equation (1)
wherein, in the equation (1), G1 is the first view image's gray level, G2 is the second view image's gray level, D_{G1,G2} means the gray difference, and Γ is the display's Gamma (γ) value.

7. The apparatus according to claim 1, wherein the residual luminance ratio is calculated by the following equation (2),
$${R}_{G 1 , G 2} = \frac{{L}_{G 1 , G 2} - {L}_{G 2 , G 2}}{{L}_{G 2 , G 1} - {L}_{G 2 , G 2}}$$
The following equation (2)
wherein, in the equation (2), G1 is the first view image's gray level, G2 is the second view image's gray level, L_{G1,G2} is a luminance value indicating the luminance detected by the light sensor when the first view image is for an observed image and the second view image is for an unobserved image, L_{G2,G1} is a luminance value indicating the luminance detected by the light sensor when the first view image is for an unobserved image and the second view image is for an observed image, L_{G2,G2} is a luminance value indicating the luminance detected by the light sensor when the stereoscopic image includes two second view images and one of the two second view images is for an observed image and another is for an unobserved image, and R_{G1,G2} means the residual luminance ratio.

8. The apparatus according to the claim 1, wherein the controller calculates the 3D interocular crosstalk using the following equation (3) or the following equation (4),
$$\begin{matrix}{X}_{LO , G 1 , G 2} = ( {( \frac{G 2}{255} )}^{γ} - {( \frac{G 1}{255} )}^{γ} ) \times \frac{{L}_{LO , G 1 , G 2} - {L}_{LO , G 2 , G 2}}{{L}_{LO , G 2 , G 1} - {L}_{LO , G 2 , G 2}} \times 100 \% & Equation ( 3 ) \\ {X}_{RO , G 1 , G 2} = ( {( \frac{G 2}{255} )}^{γ} - {( \frac{G 1}{255} )}^{γ} ) \times \frac{{L}_{RO , G 1 , G 2} - {L}_{RO , G 2 , G 2}}{{L}_{RO , G 2 , G 1} - {L}_{RO , G 2 , G 2}} \times 100 \% & Equation ( 4 )\end{matrix}$$
wherein, in the equation (3) and the equation (4), G1 is the first view image's gray level, G2 is the second view image's gray level, Γ is the display's Gamma (γ) value, L_{LO,G1,G2} is a luminance value indicating the luminance detected by the light sensor when the first view image is for an observed image on a left lens of 3D glasses and the second view image is for an unobserved image on the left lens, L_{LO,G2,G1} is a luminance value indicating the luminance detected by the light sensor when the first view image is for an unobserved image on left lens and the second view image is for an observed image on the left lens, L_{LO,G2,G2} is a luminance value indicating the luminance detected by the light sensor when the stereoscopic image includes two second view images and one of the two second view images is for an observed image on the left lens and another is for an unobserved image on the left lens, L_{RO,G1,G2} is a luminance value indicating the luminance detected by the light sensor when the first view image is for an observed image on a right lens of the 3D glasses and the second view image is for an unobserved image on the right lens, L_{RO,G2,G1} is a luminance value indicating the luminance detected by the light sensor when the first view image is for an unobserved image on right lens and the second view image is for an observed image on the right lens, L_{RO,G2,G2} is a luminance value indicating the luminance detected by the light sensor when the stereoscopic image includes two second view images and one of the two second view images is for an observed image on the right lens and another is for an unobserved image on the right lens, and X_{LO,G1,G2} and X_{RO,G1,G2} means the influence of G2 to G1, which are measured on the left lens and right lens, respectively.

9. The apparatus according to the claim 1, wherein the gray level includes at least one of a red gray level, a green gray level or a blue gray level.

10. The apparatus according to the claim 1, wherein an image pattern of the first view image includes 4% sized window box pattern and four box patterns of 1% sized window.

11. The apparatus according to the claim 10, wherein the 4% sized window box pattern are located at the center of the first view image and each of the four box patterns of 1% sized window is located at the corners of the first view image.

12. The apparatus according to the claim 10, wherein the sum of gray level of the 4% sized window box pattern and the four box patterns of 1% sized window is a maximum gray level.

13. The apparatus according to the claim 1, wherein an image pattern of the stereoscopic image is determined according to a display mode.

14. The apparatus according to the claim 13, wherein the display mode includes at least one of a gray mode, a red color mode, a green color mode or a blue color mode.

15. The apparatus according to the claim 1, wherein the controller generates 3D interocular crosstalk measurement report including at least one of measured 3D interocular crosstalk values of each of gray pairs (G1, G2), an average value of additive and subtractive interocular crosstalk or a peak value of additive and subtractive interocular crosstalk, wherein G1 is the first view image's gray level and G2 is the second view image's gray level.

16. A method of measuring a three-dimensional (3D) interocular crosstalk, comprising:
displaying a full white pattern image;
displaying a first stereoscopic image including a first view image for an observed image and a second view image for an unobserved image;
displaying the full white pattern image;
displaying a second stereoscopic image including the first view image for an unobserved image and the second view image for an observed image;
displaying a full white pattern image; and
displaying a third stereoscopic image including two second view image.

17. The method according to the claim 16, further comprising:
detecting a first luminance of the displayed first stereoscopic image;
detecting a second luminance of the displayed second stereoscopic image;
detecting a third luminance of the displayed third stereoscopic image; and
calculating 3D interocular crosstalk based on the detected first luminance, the detected second luminance and the detected third luminance.

18. The method according to the claim 17, wherein the 3D interocular crosstalk is calculated further based on gray levels of the first view image and the second view image.

19. The method according to the claim 17, wherein the 3D interocular crosstalk is calculated further based on a display's Gamma (γ) value.

20. The method according to the claim 17, wherein the 3D interocular crosstalk is calculated by the following equation (5) or the following equation (6),
$$\begin{matrix}{X}_{LO , G 1 , G 2} = ( {( \frac{G 2}{255} )}^{γ} - {( \frac{G 1}{255} )}^{γ} ) \times \frac{{L}_{LO , G 1 , G 2} - {L}_{LO , G 2 , G 2}}{{L}_{LO , G 2 , G 1} - {L}_{LO , G 2 , G 2}} \times 100 \% & Equation ( 5 ) \\ {X}_{RO , G 1 , G 2} = ( {( \frac{G 2}{255} )}^{γ} - {( \frac{G 1}{255} )}^{γ} ) \times \frac{{L}_{RO , G 1 , G 2} - {L}_{RO , G 2 , G 2}}{{L}_{RO , G 2 , G 1} - {L}_{RO , G 2 , G 2}} \times 100 \% & Equation ( 6 )\end{matrix}$$
wherein, in the equation (5) and the equation (6), G1 is the first view image's gray level, G2 is the second view image's gray level, Γ is the display's Gamma (γ) value, L_{LO,G1,G2} is a luminance value indicating the luminance of the first stereoscopic image detected on a left lens of 3D glasses, L_{LO,G2,G1} is a luminance value indicating the luminance of the second stereoscopic image detected on the left lens, L_{LO,G2,G2} is a luminance value indicating the luminance of the third stereoscopic image detected on the left lens, L_{RO,G1,G2} is a luminance value indicating the luminance of the first stereoscopic image detected on a right lens of the 3D glasses, L_{RO,G2,G1} is a luminance value indicating the luminance of the second stereoscopic image detected on the right lens, L_{RO,G2,G2} is a luminance value indicating the luminance of the third stereoscopic image detected on the right lens, and X_{LO,G1,G2} and X_{RO,G1,G2} means the influence of G2 to G1, which are measured on the left lens and right lens, respectively.
